(19) United States
(12) Patent Application Publication
(10) Pub. No.: US 2002/0184635 A1
(43) Pub. Date: Dec. 5, 2002

(54) Setting events for a set-top box using a browser-enabled device

(76) Inventor: Anthony F. Istvan, Snoqualmie, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/872,491

(22) Filed: May 31, 2001

(51) Int. Cl. G06F 3/00; H04N 5/445; G06F 13/00; H04N 7/173; H04N 7/16

(52) U.S. Cl. 725/51; 725/109; 725/131; 725/151

(57) ABSTRACT

An apparatus is disclosed which comprises a storage unit having an electronic programming guide stored thereon; a network communication interface connected to a network and to an interactive television system comprising a set-top box; and a processor, wherein the processor is operative with the network communication interface and storage unit to transmit the electronic program guide to a browser-enabled device in communication with the network, to accept commands from the browser-enabled device, and transmit the commands to the set-top box. A method is disclosed which comprises establishing a communication link via a network between a browser-enabled device and an interactive television system comprising a server and a set-top box; transmitting an electronic programming guide from the server to the browser-enabled device; receiving a command from the browser-enabled device to the server in response to information contained in the electronic programming guide; and transmitting the command from the server to the set-top box.

### TECHNICAL FIELD

This disclosure relates generally to electronic entertainment systems, and more particularly but not exclusively, relates to television networks and setting events for a set-top box of an interactive television system using a browser-enabled device.

### BACKGROUND

In recent years, television has become the predominant entertainment medium. People with widely varied interests find television to be an indispensable source of information and entertainment. Recent technologies and systems such as cable, satellite, and the Internet, have dramatically expanded television viewing options, but the great proliferation of available channels is confusing and somewhat daunting for many viewers. As a result, many viewers do not watch programming they might like to see, simply because they are unaware of it. Others may set their video cassette recorders to record a specified program, only to find that a mistake in the recorder settings, or a change in programming, resulted in the wrong program being recorded.

Programming guides are a widely-used way of informing television viewers of the available programming, but known programming guides are deficient in many areas. Written programming guides, for example, require significant lead time to print and distribute. Consequently, programming changes that occur after printing do not appear in the written programming guides. Additionally, a viewer must obtain a new programming guide periodically (e.g., weekly) in order to keep the written information current.

An alternative to written programming guides is the electronic programming guide (EPG), which provides an on-screen listing of all programming and content available to television service subscribers. Although they are an improvement over written programming guides, existing EPGs also have a number of disadvantages. For example, many such EPGs tend to occupy most or all of the television screen, so that a viewer cannot simultaneously view programs and the EPG. The viewer, therefore, is unable to determine what is showing on other channels without interrupting the viewing of the current channel. This is especially problematic when there is a group of viewers, some of whom are intensely interested in the programming currently on the television, while others wish to see what other programs are available.

An additional and substantial disadvantage of current EPGs is that they can only be viewed at one physical location, usually on the consumer's own television. Consequently, the EPG cannot be viewed and interacted with at a different location. For example, if a consumer needs to work late but would like to record a program, he would be out of luck unless he could go home, view the EPG to obtain the program's start time and channel, and then program his recording device before the start of the program.

Therefore, improvements are needed in the remote accessibility of programming information to viewers.

### BRIEF DESCRIPTION OF THE DRAWINGS

Non-limiting and non-exhaustive embodiments of the present invention are described below with reference to the following figures, wherein like reference numerals refer to like parts throughout the various views unless otherwise specified.

FIG. 1 is a schematic of an embodiment of a television network.

FIG. 2 is a schematic block diagram of an embodiment of end-user equipment for an interactive television system.

FIG. 3 is a schematic block diagram of an embodiment of a set top box.

FIG. 4 is a drawing of an embodiment of an electronic programming guide (EPG).

FIG. 5 is a flowchart of an embodiment of a method for using an apparatus of FIG. 1 to remotely program a set-top box or a recording device attached thereto.

### DETAILED DESCRIPTION OF THE ILLUSTRATED EMBODIMENTS

Embodiments of a system and method for remotely scheduling events on a set-top box that forms part of an interactive television network are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

References throughout this specification to “one embodiment” or “an embodiment” mean that a particular feature, structure, or characteristic described in connection with the embodiment is included in at least one embodiment of the present invention. Thus, the appearances of the phrases “in one embodiment” or “in an embodiment” in various places throughout this specification do not necessarily all refer to the same embodiment. Furthermore, the particular features, structures, or characteristics may be combined in any suitable manner in one or more embodiments.

Embodiments of the present invention offer benefits not available in conventional approaches. By allowing consumers to remotely access and program their set-top box (STB), a consumer may conveniently check television program listings from any location and instruct a set-top box to carry out some action, such as programming a recording device. Use of a database having the electronic programming guide (EPG) information ensures that the consumer has access to the most complete and current programming information. Moreover, use of the EPG ensures that the consumer can quickly and accurately command their STB to take an action.

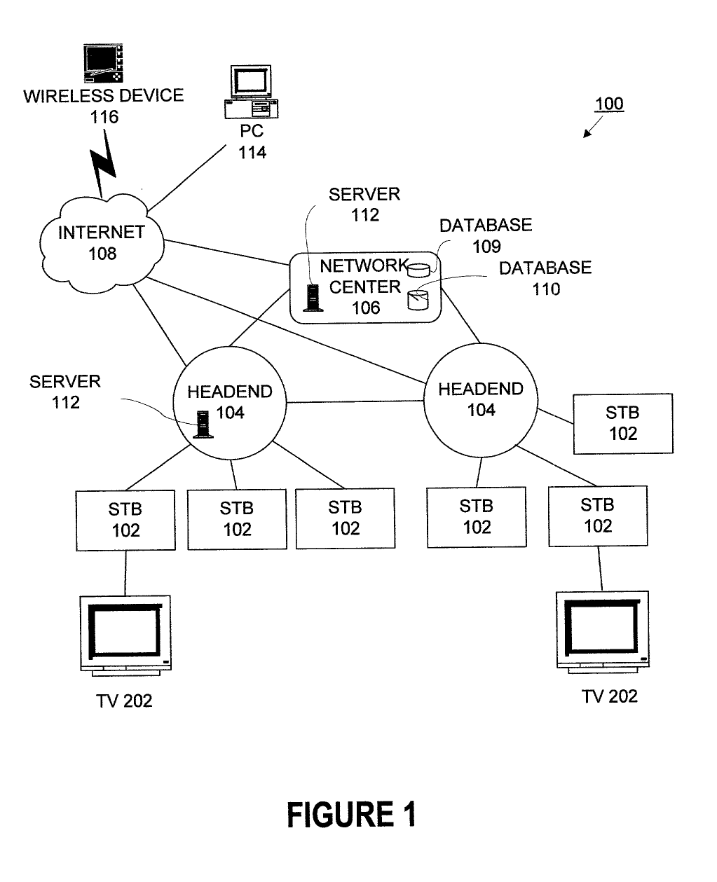

FIG. 1 illustrates an embodiment of a television network 100, such as a cable television (CATV) network. Of course, the illustrated network topology is provided for example purposes only, and other networks and network configurations may be used within the scope of the invention. The television network 100 generally includes a network center 106 connected to one or more headends 104, with each headend 104 in turn connected to one or more STBs 102. STBs connect televisions 202 to the network 100, and are typically located in the homes of consumers registered to receive content from the network. As shown, both the network center 106 and headends 104 can be connected to an external network, such as an Internet 108, using a variety of well-known network communication interfaces, such as a modem, cable modem, wireless modem, Ethernet, and the like. A variety of browser-enabled devices such as personal computer (PC) 114 and a wireless device 116 can also communicate with the network 100 and its various components by virtue of a connection to the Internet 108. In the television network 100, content can originate at the network center 106 and is transmitted from the network center 106 to the headends 104. Each headend 104 then transmits content to each STB 102 connected to it. The STB 102, among other things, tunes to and displays the selected channel on the television 202.

A function of the network center 106 is to gather television content, such as broadcast signals from content providers, and transmit it throughout the system 100. The network center 106 includes a server 112 that communicates with the Internet 108, and includes a database 109 containing programming information for all the broadcast signals transmitted through the network 100. The database 109 may include, for example, program channels, dates, times, critical reviews, content ratings, VCRPlus® codes, and the like. In various embodiments, copies of the database 109 are periodically transmitted from the headends 104 or network center 106 to the STBs 102 for local storage and use by the consumer. For example, using a “carousel” technique, a headend 104 may be configured to automatically send updated programming information to the STBs 102. In the carousel technique, a headend 104 sends a certain number of data packets including, for example, television program schedule information, in a particular sequence and then repeats the sequence at regular intervals. Programming information from the database 109 can also be downloaded on demand to the PC 114 or wireless device 116 via the Internet 108. The network 106 center also includes a database 110 containing subscriber information, such as names, passwords, and addresses of each subscriber's STB 102. This information allows a consumer using the PC 114 or wireless device 116 to log into the network 100 via the Internet 108 and interact with the STB 102 located in their home. In another embodiment, a consumer may have more than one STB; in such a case the database 110 can contain multiple STB addresses usermame/password combination, allowing the consumer to select one or more of their STBs to which to send a command.

In the context of a cable TV network, a headend 104 is a central facility where CATV transmissions can be received from a local CATV satellite downlink and packaged together for transmission to customer homes. Headends 104 are coupled to one another, either directly or through the network center 106. In some cases, headends 104 may be connected via a separate network, one particular example of which is an Internet 108. Although described above as located in the network center 106, the server 112, the database 109 containing television programming information, and the database 110 containing consumer information can also be stored within one or more of the headends 104, the Internet 108, or a third party system coupled in one way or another to the headends 104.

Each STB 102 is typically located on or near the television 202, and serves as a gateway between the television and a broadband communication network, such as a cable network. Each STB 102 is connected to a headend 104, through which it receives encoded television signals from the network 100 and decodes the signals for display on the television. The STB 102 generally operates in conjunction with data streams encoded using the MPEG standard, although it can be made to operate with other encoding standards as well. Each STB 102 is also capable of two-way data streams, allowing consumers to access services such as electronic shopping and video-on-demand using their televisions. Additionally, the STB 102 can receive commands from, and send commands to, the PC 114 or wireless device 116 via the network 100 and the Internet 108.

The PC 114 or wireless device 116 can be connected to the external network, such as the Internet 108, using a variety of well-known network communication interfaces, such as a modem, cable modem, wireless modem, Ethernet, and the like. Although examples shown include a personal computer and wireless device, any browser-enabled device can be used, including laptops, cellular telephones or personal digital assistants (PDAs). This connection allows the browser-enabled device to communicate with the network center 106, the headends 104 and, ultimately, with the STBs 102. Since the Internet 108 can be accessed virtually anywhere in the world, the PC 114 or wireless device 116 can thus be used by consumers to communicate with their own STB from wherever they happen to be. This overcomes one of the major disadvantages of the prior art—that the programming information could only be seen, and the STB could only be interacted with, wherever the consumer's television and STB were located.

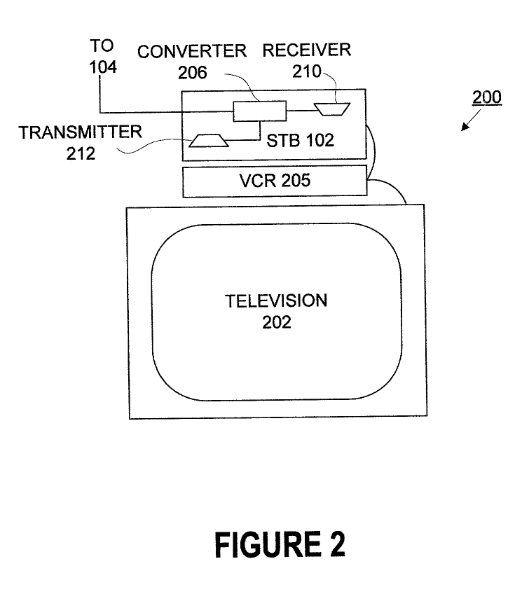

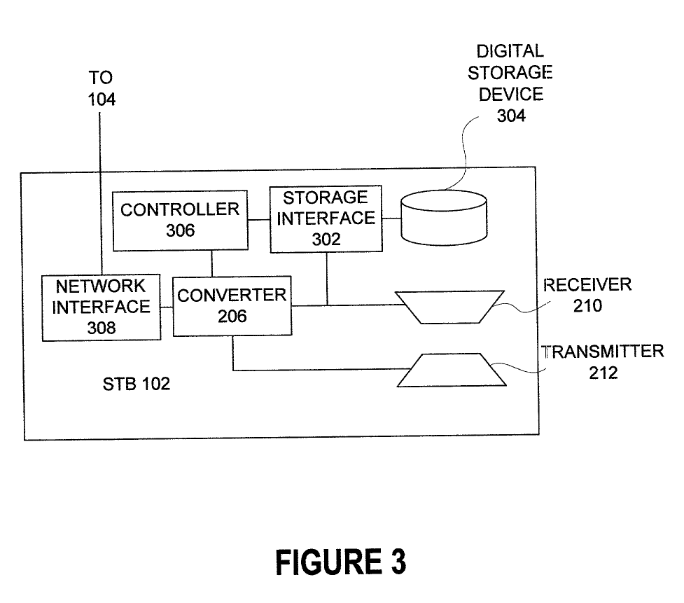

FIG. 2 illustrates an embodiment of end-user equipment 200 used in connection with an interactive television system. In the embodiment shown, the end-user equipment 200 includes an STB 102 and a television 202. The STB 102 is usually controlled with a portable remote control unit (not shown) in the consumer's home. The system 200 may optionally include a video cassette recorder (VCR) 205, digital video recorder (DVR) or some other recording device. Although shown as a VCR 205 external to the STB 102, the recording device may be incorporated inside the STB. For example, the digital storage device 304 (see e.g., FIG. 3) inside the STB 102 can be used as a DVR or personal video recorder (PVR), or the STB 102 may have other recording functionality.

In the illustrated embodiment, the STB 102 is equipped with a receiver 210, such as an infrared (IR) or radio frequency (RF) receiver. The receiver 210 can receive control signals from the remote control for operating the STB 102 and the television 202. The receiver 210 may also receive other types of data, such as information requests, e-mail, and the like, for transmission to the network 100. In one implementation, the STB 102 also includes a transmitter 212, such as an IR or RF transmitter 212. The transmitter 212 is configured, in one embodiment, to broadcast various types of information to the remote control, such as television program schedule information, responses to information requests, e-mail, and the like.

The television 202 may be configured to display television signals in a variety of formats, including standard analog or digital television formats or high-definition television (HDTV) formats. The television 202 may utilize various technologies to display the television signals, such as standard cathode ray tube (CRT) technology, liquid crystal display (LCD) technology, liquid plasma technology, or projection techniques. As illustrated, the television 202 can be coupled to an STB 102 to receive and display television signals received from the network 100, and more specifically, from a headend 104. In one embodiment, the STB 102 includes a converter 206 for converting digitally encoded (e.g., MPEG) television signals from the network 100 into format directly readable by the television 202. Additionally, as described in greater detail below, the converter 206 may decode television program schedule information or other data received from the network 100, including commands or other instructions to record a television programs or event, or to perform some other action.

FIG. 3 shows an expanded block diagram of an embodiment of an STB 102. The STB 102 may include a number of additional components beyond those depicted in FIG. 2. For example, the STB 102 may include a storage interface 302, which provides an interface with a digital storage device 304, such as a hard disk drive or other memory device. In one embodiment, the storage interface 302 receives video/audio information, such as program previews and the like, from the converter 206 and delivers the same to the digital storage device 304 for storage. The storage device 340, if of sufficient capacity, can also function as a DVR internal to the STB 102. In one embodiment, the STB 102 further includes a controller 306 that is in communication with the storage interface 302 and the converter 206. The controller 306 may be embodied as a micro-controller, microprocessor, digital signal processor (DSP) or other device known in the art. The controller 306 may manage the operation of the STB 102, including, for example, reception of the television program schedule information from the network 100, storage and retrieval of supplemental video/audio information, and the like. In one embodiment, the STB 102 includes a separate network interface 308 for providing access to the network 100. The type of network interface 308 can vary depending on the underlying network 100. In a cable network, for instance, the network interface 308 may comprise a cable modem or the like. In other embodiments, the functionality of the network interface 308 can be provided by the converter 206. In yet other embodiments, the network interface 308 can provide access to the Internet 108 without necessarily having to go through the headend 104, such as if the network interface 308 is connected to a telephone line, digital subscriber line (DSL) network, or other network.

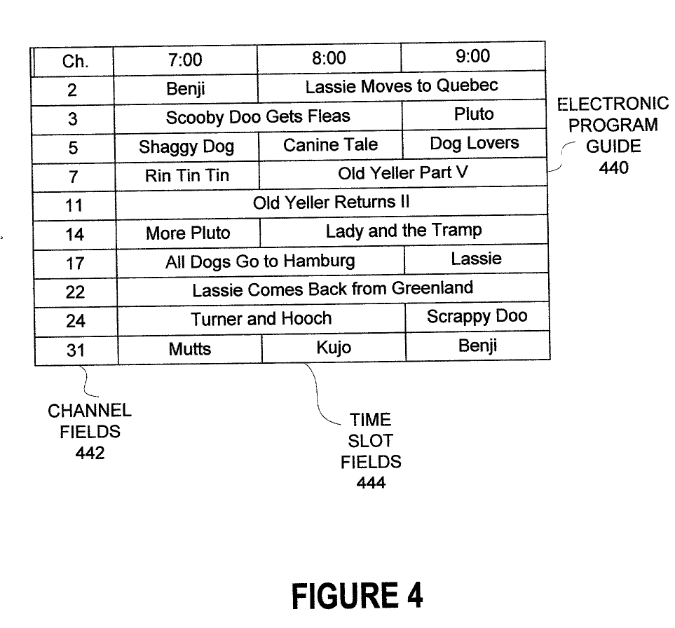

FIG. 4 illustrates an embodiment of an electronic program guide (EPG) 440 which is a user interface for displaying television program schedule information transmitted from database 109 on the network center 106 or the headend 104 to the PC 114 or wireless device 116 via the Internet 108, thus providing a consumer with the necessary information for programming the STB 102 or a device connected to it, such as the VCR 205. In one embodiment, the EPG 440 can be provided as a hypertext markup language (HTML) file, using a protocol such as hypertext transfer protocol (HTTP). For the sake of simplicity of explanation, the EPG 440 will be described hereinafter in the context of HTTP and HTML. Other embodiments of the EPG 440 (and associated television program schedule information) can be provided using other formats and/or protocols, such as file transfer protocol (FTP), transmission control protocol/Internet protocol (TCP/IP), user datagram protocol (UDP), extensible markup language (XML) format, and the like. In addition, different embodiments of the EPG 440 can be provided for each of the different devices upon which the EPG can be displayed. For example, a smaller version of the EPG 440 can be provided which can be viewed on the small display screen usually found on cellular telephones. In another example, the EPG could comprise a series of pull-down menus better adapted to the small size of a cell phone screen.

In the EPG 440, channel fields 442 may be vertically arranged as rows, in ascending order, along the left edge of the EPG 440. Each of the channel fields 442 may correspond to a single channel available from the network 100. Time slot fields 444 may be provided in columns to indicate which programs are on a given channel at a given time. In other embodiments, channel fields may be arranged as columns and time slot fields may be arranged as rows. A system for displaying television program schedule information is disclosed in U.S. Pat. No. 5,532,754, entitled “BACKGROUND TELEVISION SCHEDULE SYSTEM,” which is incorporated herein by reference in its entirety. Several time increments may be simultaneously depicted, so that a viewer can see an overview of television program schedule information corresponding to the present time and for several hours thereafter without having to scroll the EPG 440 to view additional time increments. Nevertheless, a consumer may scroll the EPG 440 on the PC 114 or the wireless device 116 vertically to see programming for additional channels, or horizontally to see additional time slots. These various modifications are intended herein to be illustrative and non-exhaustive.

If after reviewing the EPG 440 the consumer finds a program of interest, he or she enters a command through the browser of the PC 114 or the wireless device 116 to request that the program be recorded. The command can be entered manually, for example by typing the channel, start time, stop time, and the like, and is sent to the network center 106 from the Internet 108. Alternatively, or in addition, the EPG 440 can be configured to have commands embedded in the program indications of the EPG 440, such that the command is issued automatically in response to the consumer's selection of an indication of the desired program in the EPG 440, instead of requiring manual entry. The embedded commands may include instructions to program the VCR 205 or other recording device. In one embodiment, an appropriate VCRPlus® code is transmitted from the database 109 to the VCR 205 in response to a consumer selection of a program from the EPG 440. A viewer may thus rapidly program a VCR 205 with a much lower probability of error. In another embodiment of the EPG 440, JavaScript™ or other suitable code for action control can be added to the HTML file or page to allow the STB 102 to change channels, schedule recording by the VCR 205, or take other actions to control television viewing.

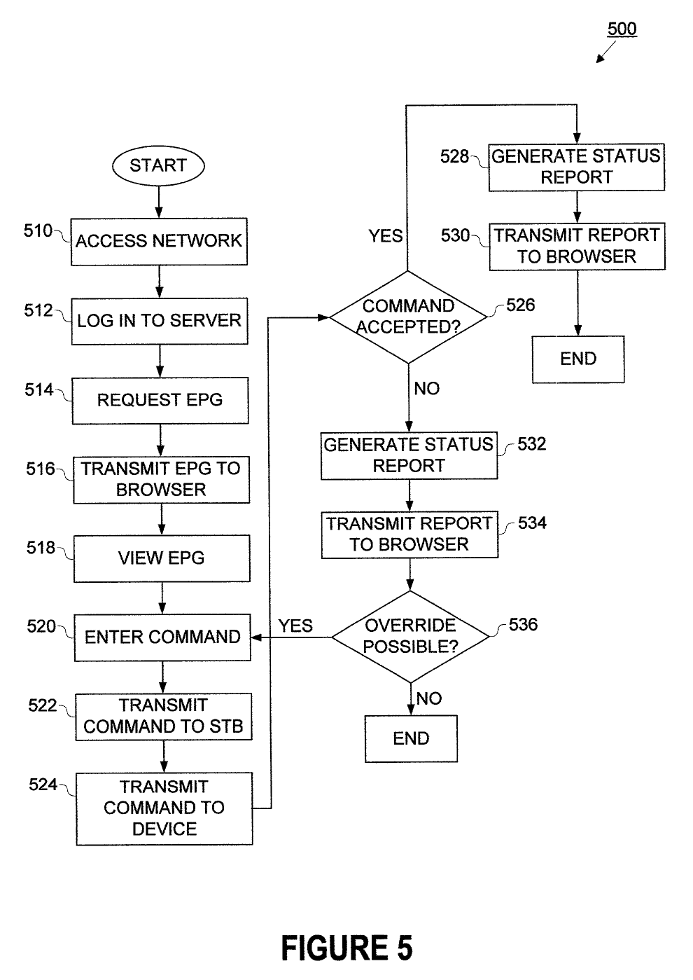

FIG. 5 illustrates an embodiment of a method for remotely obtaining and viewing television program schedule information in the form of the EPG 440, and using the EPG 440 to program a recording device. Although the embodiment is described in the context of programming a recording device connected to the STB 102, the method can also be used to send other types of commands to the STB 102, for example commands for control operations, such as volume adjustment, picture/color adjustment, fine tuning, and the like. The method 500 begins at 510, where a consumer uses the PC 114 or wireless device 116 and the Internet 108 to establish a connection to the server 112 located at the headend 104 or network center 106. Once the connection to the proper site is established, at 512 the consumer logs into the server 112 by entering a username and password, which the server 112 authenticates by accessing the database 110 to verify if the entered password matches the entered username. If the password matches the username, then the consumer is allowed further interaction with the server 112, and the address of the consumer's STB 102 is retrieved from the database 110 so that it can be used to direct the consumer's commands to their own STB 102. In cases where the consumer has more than one STB, the addresses of all STBs which the consumer can access are retrieved from the database 110, and the consumer is given a choice of one or more of the STBs to which they wish to send commands.

Once the consumer successfully logs in at 512, the method proceeds to 514, where the browser running on the consumer's browser-enabled device (e.g., the PC 114 or the wireless devices 116) sends a request to the server 112 asking that the server 112 transmit the relevant programming information. In one embodiment, such a request may be an HTTP request to access and view the EPG 440. At 516, the programming information is transmitted to the browser-enabled device in the form of an electronic programming guide (EPG), such as EPG 440 described above. At 518, the consumer views the EPG 440 to see if there is a program desired for recording. This viewing can include activities such as scrolling, enlarging, and the like. If there is a program the consumer wishes to record, then at 520 the consumer enters a command to be sent to the proper STB 102 requesting that it set the recording device to record the given program on the given channel at the given time. As explained above in connection with the EPG 440, the consumer may either enter these commands into their browser manually (e.g., type them in) after reviewing the programming information, or, if the EPG 440 is enabled with commands embedded in the EPG entries, simply select the program from the EPG 440, whereupon the EPG 440 automatically sends the appropriate command to the STB 102 over the Internet 108.

Once the consumer's command is entered, at 522 the command is transmitted via the Internet 108 to the server 112, which, having discerned the address of the consumer's STB 102 from the database 110, routes the command to the proper STB 102. At 524, the STB 102 routes the command to the appropriate device, such as the VCR 205, for execution. Upon receiving the command, the STB 102 or the VCR 205 checks at 526 to see if the received command can be executed. For example, if the VCR 205 is already set to record another program at the time being requested, then the command cannot be executed. Alternatively, or in addition, if the VCR 205 or other recording device indicates that there is not sufficient storage left to record the requested program, the command cannot be carried out.

If the command sent to the recording device via the STB 102 can be executed, then at 528 the STB 102 generates a status report, and at 530 transmits the report to the consumer via the server 112 and the Internet 108, to inform the consumer of the status of their command. If the consumer's command cannot be executed, then at 532 the STB 102 generates a status report and transmits the report to the browser-enabled device at 534. The status report can optionally give the consumer a choice of, for example, overriding a previous command in case of conflicting requests, or requesting that the device erase or overwrite existing recorded programs in case of insufficient storage space. At 536, the method checks to see if the consumer is given this override option; if there is an override option, then the method returns to 520 and awaits entry of an appropriate command. In cases where the consumer has multiple STBs, the status report can also give him the option of sending a command to another of his STBs.

The above description of illustrated embodiments of the invention, including what is described in the Abstract, is not intended to be exhaustive or to limit the invention to the precise forms disclosed. While specific embodiments of the invention are described herein for illustrative purposes, various equivalent modifications are possible within the scope of the invention, as those skilled in the relevant art will recognize. These modifications can be made to the invention in light of the above detailed description. For instance, while various embodiments have been described above as using a PC 114 to directly obtain the EPG 440, other devices can obtain the EPG 440 instead of, or in addition to, the remote control 204. A PC connected to the Internet 108 can be used by the consumer to obtain the EPG 440, and invoke action controls of the EPG to control recording devices attached to the STB from the PC. Furthermore, multiple browser-enabled devices (such as PCs) can be used in parallel to allow multiple consumers to independently view the EPG 440 and correspondingly send commands to their STB 102.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a storage unit having programming information stored thereon;
a network communication interface connected to a network and to an interactive television system comprising a set-top box; and
a processor, wherein the processor is operative with the network communication interface and storage unit to transmit the programming information to a browser-enabled device in communication with the network, to accept a command from the browser-enabled device, and to transmit the command to the set-top box.

2. The apparatus of claim 1 wherein the programming information can be displayed on the browser-enabled device as an electronic programming guide (EPG).

3. The apparatus of claim 2 wherein each program displayed in the electronic programming guide has commands embedded therein, that are capable of being issued in response to selection of the displayed program.

4. The apparatus of claim 1 wherein the browser-enabled device comprises a computer, a personal digital assistant (PDA) or a cellular telephone.

5. The apparatus of claim 1 wherein the processor is further operative to receive a status report from the set-top box and to transmit the status report to the browser-enabled device.

6. The apparatus of claim 5 wherein the status report includes information about whether the command sent to the set-top box was successfully executed.

7. The apparatus of claim 5 wherein the status report includes information about why the command was not successfully executed.

8. The apparatus of claim 1 wherein the processor is further operative to receive from the browser-enabled device another command to correct a condition that led to a non-execution of a previous command.

9. The apparatus of claim 1 wherein the set-top box is operative to transmit commands to a device attached thereto.

10. The apparatus of claim 9 wherein the device comprises a recording device attached to the set-top box.

11. The apparatus of claim 10 wherein the recording device comprises a video cassette recorder (VCR) or a digital video recorder (DVR).

12. The apparatus of claim 1 wherein the processor is further operative to send commands to at least one additional set-top box.

13. A system, comprising:
an interactive television system comprising a server and a set-top box;
a network connected to the server; and
a browser-enabled device connected to the network, wherein the browser-enabled device is operative with the network and the server to receive programming information over the network, accept commands from a user of the browser-enabled device, and transmit the commands to the set-top box via the network.

14. The system of claim 13 wherein the programming information can be displayed on the browser-enabled device as an electronic programming guide (EPG).

15. The system of claim 14 wherein each program displayed in the electronic programming guide has commands embedded therein that are capable of being issued via selection by the displayed program.

16. The system of claim 13 wherein the browser-enabled device comprises a computer, a personal digital assistant (PDA) or a cellular telephone.

17. The system of claim 13 wherein the server is further operative to receive a status report from the set-top box and to transmit the status report to the browser-enabled device.

18. The system of claim 17 wherein the status report includes information about whether the command sent to the set-top box was successfully executed.

19. The system of claim 17 wherein the status report includes information about why the command was not successfully executed.

20. The system of claim 13 wherein the server is further operative to receive from the browser-enabled device another command to correct a condition that led to a non-execution of a previous command.

21. The system of claim 13 wherein the set-top box is operative to transmit commands to a device attached thereto.

22. The system of claim 21 wherein the device comprises a recording device attached to the set-top box.

23. The system of claim 22 wherein the recording device comprises a video cassette recorder (VCR) or a digital video recorder (DVR).

24. The apparatus of claim 13 wherein the processor is further operative to send commands to at least one additional set-top box.

25. A method, comprising:
establishing a communication link via a network between a browser-enabled device and an interactive television system comprising a server and a set-top box;
transmitting programming information from the server to the browser-enabled device;
receiving a command from the browser-enabled device to the server in response to the programming information; and
transmitting the command from the server to the set-top box.

26. The method of claim 25, further comprising displaying the programming information on the browser-enabled device as an electronic programming guide (EPG) user interface.

27. The method of claim 26 wherein establishing the communication link between the browser-enabled device and the server comprises logging the browser-enabled device into the server.

28. The method of claim 25, further comprising transmitting a status report from the set-top box to the browser-enabled device via the network.

29. The method of claim 25, further comprising transmitting another command from the browser-enabled device to the set-top box to correct a condition in which the set-top box cannot execute a previously sent command.

30. The method of claim 25, further comprising transmitting the command from the set-top box to a device attached thereto.

31. The method of claim 30 wherein the device attached to the set-top box comprises a recording device.

32. The method of claim 31 wherein the recording device comprises a video cassette recorder (VCR) or a digital video recorder (DVR).

33. The method of claim 25 wherein the browser-enabled device comprises a network-compatible device.

34. The method of claim 33 wherein the browser-enabled device comprises a computer, a cellular telephone, a personal digital assistant, or a handheld computer.

35. The method of claim 25 further comprising transmitting commands to at least one additional set-top box.

36. An article of manufacture, comprising:
a machine-readable medium having instructions stored thereon to:
establish a communication link via a network between a browser-enabled device and an interactive television system comprising a server and a set-top box;
transmit programming information from the server to the browser-enabled device;
transmit a command from the browser-enabled device to the server in response to the programming information; and
transmit the command from the server to the set-top box.

37. The article of manufacture of claim 36 wherein the instructions further include instructions to display the programming information on the browser-enabled device as an electronic programming guide (EPG) user interface.

38. The article of manufacture of claim 36 wherein the instructions further include instructions to establish a communication link between the browser-enabled device and the server by logging the browser-enabled device into the server.

39. The article of manufacture of claim 36 wherein the instructions further include instructions to transmit a status report from the set-top box to the browser-enabled device via the network.

40. The article of manufacture of claim 36 wherein the instructions further include instructions to transmit another command from the browser-enabled device to the set-top box to correct a condition in which the set-top box cannot execute a previously sent command.

41. The article of manufacture of claim 36 wherein the instructions further include instructions to transmit the command from the set-top box to a device attached thereto.

42. The article of manufacture of claim 36 wherein the instructions further include instructions to transmit the command to at least one additional set-top box.

43. An apparatus, comprising:
a storage unit having programming information stored thereon;
a network communication interface connected to a network and to an interactive television system comprising a set-top box; and
a processor, wherein the processor is operative with the network communication interface and storage unit to transmit the programming information to a browser-enabled device in communication with the network, to display the programming information on the browser-enabled device as an electronic programming guide (EPG) user interface, to accept a command from the browser-enabled device, and to transmit the command to the set-top box.

44. A method, comprising:
establishing a communication link via a network between a browser-enabled device and an interactive television system comprising a server and a set-top box;
transmitting programming information from the server to the browser-enabled device;
displaying the programming information on the browser-enabled device as an electronic programming guide (EPG) user interface;
receiving a command from the browser-enabled device to the server in response to the programming information; and
transmitting the command from the server to the set-top box.

45. A system, comprising:
an interactive television system comprising a server and a set-top box, wherein the server comprises a processor, a network communication interface, and a storage unit comprising a storage medium, a writing element for writing information thereon, and a reading element for reading information therefrom, and wherein the storage medium has programming information stored thereon;
a network connected to the network communication interface of the server, wherein the server is capable of sending information and receiving information over the network; and
a browser-enabled device connected to the network, wherein the browser-enabled device is operative with the network and the server to receive programming information stored on the storage medium over the network, accept input of a command from a user of the browser-enabled device, and transmit the command to the set-top box via the network and the server.

46. A method, comprising:
establishing a communication link via a network between a browser-enabled device and an interactive television system comprising a server and a set-top box, wherein the server comprises a processor, a network communication interface, and a storage unit comprising a storage medium, a writing element for writing information thereon, and a reading element for reading information therefrom, wherein the storage medium has programming information stored thereon;
transmitting the programming information from the server to the browser-enabled device, wherein the programming information is read from the storage medium by the reading element and transmitted to the network communication interface for transmission to the browser-enabled device via the network;
receiving a command via the network from the browser-enabled device to the server in response to the programming information; and
transmitting the command from the server to the set-top box.
